(19) United States
(12) Patent Application Publication
(10) Pub. No.: US 2020/0189583 A1
(43) Pub. Date: Jun. 18, 2020

(54) LANE MOTION RANDOMIZATION OF AUTOMATED VEHICLES

(71) Applicant: Intel Corporation, Santa Clara, CA (US)

(72) Inventor: Igor Tatourian, Fountain Hills, AZ (US)

(21) Appl. No.: 16/637,589

(22) PCT Filed: Sep. 29, 2017
(86) PCT No.: PCT/US2017/054539

§ 371 Date: Feb. 7, 2020

(51) Int. Cl. B60W 30/12; B60W 60/00; G08G 1/00; G06K 9/00; G06K 9/62; G06F 16/29; H04W 4/46

(52) U.S. Cl. CPC B60W 30/12; B60W 60/0018; B60W 60/0025; H04W 4/46; G06K 9/00798; G06K 9/6267; G06F 16/29; G08G 1/22

(57) ABSTRACT

Various systems and methods for providing a vehicle control system are described herein. A system for managing an autonomous vehicle includes a vehicle control system to determine a travel path in a road lane, the travel path being offset from a center of the road lane by an offset value and steer the autonomous vehicle to follow the travel path.

### TECHNICAL FIELD

Embodiments described herein generally relate to vehicle controls and in particular, to a vehicle control system to mitigate road wear.

### BACKGROUND

Autonomous vehicles, also referred to as self-driving cars, driverless cars, uncrewed vehicles, or robotic vehicles, are vehicles capable of replacing traditional vehicles for conventional transportation. Elements of autonomous vehicles have been introduced slowly over the years, such as through the use of advanced driver assistance systems (ADAS). ADAS are those developed to automate, adapt, or enhance vehicle systems to increase safety and provide better driving. In such systems, safety features are designed to avoid collisions and accidents by offering technologies that alert the driver to potential problems, or to avoid collisions by implementing safeguards and taking over control of the vehicle.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to control an autonomous vehicle, according to an embodiment;

FIG. 2 is a data flow diagram illustrating a process and system to control steering in an autonomous vehicle, according to an embodiment;

FIG. 3 is a block diagram illustrating a system for managing an autonomous vehicle, according to an embodiment;

FIG. 4 is a flowchart illustrating a method of managing an autonomous vehicle, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide mechanisms to manage autonomous vehicles in order to mitigate road wear. Highly-automated vehicles have capabilities to determine where they are, what is around them, and where they need to move. Motion planning algorithms are designed to keep a vehicle within a lane with a certain precision, such as toward the center of the lane, for a straight motion path. If many vehicles are programmed to follow the same driving path, then the vehicles may create ruts in the road and the road may wear down prematurely. What is needed is a way to operate autonomous vehicles in a manner that does not cause this type of repetitive road wear.

The disclosure provides several methods to offset a vehicle's path in the lane to mitigate road wear. In one aspect, use of imaging techniques, such as a very high frequency (VHF) radar, may be used to determine road condition and alter the vehicle's path in response. In another aspect, a random variable may be introduced into a pathing algorithm to cause the vehicle to travel over a randomized path. In yet another aspect, other sensors may be used to adjust when there are multiple vehicles in close proximity—either in the same lane or in adjacent lanes. Various other aspects are discussed throughout this document. Aspects may be combined and modified to incorporate one aspect with one or more other aspects.

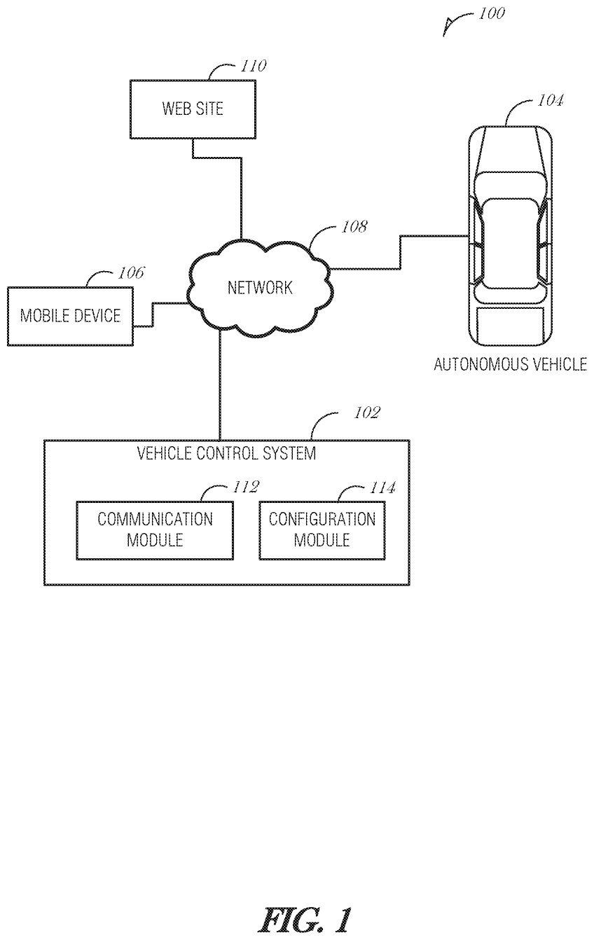

FIG. 1 is a schematic drawing illustrating a system 100 to control an autonomous vehicle, according to an embodiment. FIG. 1 includes a vehicle control system 102 and an autonomous vehicle 104 communicatively coupled via a network 108. A mobile device 106 may be used to interface with the autonomous vehicle 104 or the vehicle control system 102.

The autonomous vehicle 104 may be of any type of vehicle, such as a commercial vehicle, consumer vehicle, or recreation vehicle able to operate at least partially in an autonomous mode. The autonomous vehicle 104 may operate at some times in a manual mode where the driver operates the vehicle 104 conventionally using pedals, steering wheel, and other controls. At other times, the autonomous vehicle 104 may operate in a fully autonomous mode, where the vehicle 104 operates without user intervention. In addition, the autonomous vehicle 104 may operate in a semi-autonomous mode, where the vehicle 104 controls many of the aspects of driving, but the driver may intervene or influence the operation using conventional (e.g., steering wheel) and non-conventional inputs (e.g., voice control).

The vehicle 104 includes a sensor array, which may include various forward, side, and rearward facing cameras, radar, LIDAR, ultrasonic, very high-frequency (VHF) radar, or the like. Forward-facing is used in this document to refer to the primary direction of travel, the direction the seats are arranged to face, the direction of travel when the transmission is set to drive, or the like. Conventionally then, rear-facing or rearward-facing is used to describe sensors that are directed in a roughly opposite direction than those that are forward or front-facing. It is understood that some forward-facing cameras may have a relatively wide field of view, even up to 180-degrees. Similarly, a rear-facing camera that is directed at an angle (perhaps 60-degrees off center) to be used to detect traffic in adjacent traffic lanes, may also have a relatively wide field of view, which may overlap the field of view of a forward-facing camera. Side-facing sensors are those that are directed outward from the sides of the vehicle 104. Cameras in the sensor array may include infrared or visible light cameras, able to focus at long-range or short-range with narrow or large fields of view.

The autonomous vehicle 104 includes an on-board diagnostics system to record vehicle operation and other aspects of the vehicle's performance, maintenance, or status. The autonomous vehicle 104 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

The mobile device 106 may be a device such as a smartphone, cellular telephone, mobile phone, laptop computer, tablet computer, or other portable networked device. In general, the mobile device 106 is small and light enough to be considered portable and includes a mechanism to connect to the network 108, either over a persistent or intermittent connection.

The network 108 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 108 may include a single local area network (LAN) or wide-area network (WAN), or combinations of LANs or WANs, such as the Internet. The various devices (e.g., mobile device 106 or vehicle 104) coupled to the network 108 may be coupled to the network 108 via one or more wired or wireless connections.

The network 108 may also encompass in-vehicle networks, such as an on-board diagnostic network (e.g., OBD II) CANbus, Bluetooth, Ethernet, or other in-vehicle, short-range, small-area, or personal networks.

The vehicle control system 102 may include a communication controller 112 to interface with the mobile device 106 or the autonomous vehicle 104 and pass control and data to monitor environmental events, vehicle activity, vehicle status, geographical location, and the like. The vehicle control system 102 may use the communication controller 112 to communicate with sensors on the autonomous vehicle 104 to gather information about the road surface, weather events, time of day, location, route, other vehicles in the area, or the like. Using this data, the vehicle control system 102 is able to determine potential obstacles in the road and initiate mitigation operations, such as braking, steering, or alerting the driver. The communication controller 112 may operate over the network 108 and may access the web site 110 to acquire data about potential obstacles or road conditions along the route of the autonomous vehicle 104. The communication controller 112 may also upload data about experiences at the autonomous vehicle 104 (e.g., after experiencing a road rut, data describing the road rut may be uploaded to the web site 110 to update a road condition database).

The vehicle control system 102 may also include a configuration controller 114. The driver may configure the vehicle control system 102 to react in certain ways depending on the type, severity, location, or other aspects of the road conditions, traffic, or other environmental factors. The driver's configuration may be stored in or accessed by the configuration controller 114. Different drivers may store different driver preferences (e.g., a husband may store one set of preferences and his wife may store a different set of preferences each of which may be accessed by the configuration controller 114 to configure the vehicle control system 102.

In operation, the autonomous vehicle 104 may operate in one or more modes depending on the current configuration of the autonomous vehicle 104. In a first mode, the autonomous vehicle 104 operates in a reactive manner based on sensor information obtained by the autonomous vehicle 104. The vehicle control system 102 may obtain sensor data from onboard sensors, such as a radar system, and determine where there is road wear that may indicate ruts or other road deterioration. Sensors may be on-vehicle or off-vehicle. For instance, the sensors may be built into or incorporated into the autonomous vehicle 104 in mirrors, grill, rearview mirror, or other components. Alternatively, the sensors may be placed roadside, such as in a streetlight or other installation. The vehicle control system 102 may interface with the sensors using short-range or long-range wireless interfaces (e.g., WiFi, Bluetooth, etc.).

In an embodiment, the autonomous vehicle 104 is able to access a repository of road conditions and take preemptive action to change the lane placement of the autonomous vehicle 104. The repository may be hosted in a shared network location (e.g., web site 110, a cloud location, a distributed database, etc.) or be locally hosted (e.g., in the vehicle 104 or in the mobile device 106). The repository may include a location of the road condition (e.g., GPS coordinates, street intersection, mile marker, etc.), a description or type of the condition (e.g., road rut, uneven pavement, etc.), a severity of the obstacle (e.g., rated from 1 to 10 on a scale of dangerousness), source (e.g., from the driver, from a vehicle sensor, from an online user in a crowdsourced context, etc.), and other properties of the road condition. Using this data, the autonomous vehicle 104 is able to gently and subtly change the operation of the autonomous vehicle 104 to mitigate overuse of certain portions of the road lane.

In a second mode, the autonomous vehicle 104 uses a random offset as an input into a lane motion stabilization algorithm. An unmodified lane motion stabilization algorithm may be designed or configured to navigate the autonomous vehicle 104 to the center of the lane. As an example, in the United States, the highway system uses a 12-foot standard lane width. While lane widths may vary based on the type of road, volume and speed of traffic on such roads, and other aspects, lane widths are typically wide enough to allow adjustments for a passenger vehicle to maneuver left or right and still maintain placement in the lane. A random offset may be introduced into the navigation of autonomous vehicle 104 so that the autonomous vehicle 104 travels down the lane left or right of the centerline, but still within the lane. Even a change of a few inches from the centerline of the lane may mitigate road wear and avoid the formation of ruts.

When operating in the second mode, the autonomous vehicle 104 may encounter other vehicles in adjacent lanes either lanes with traffic in the same direction or in the opposite direction of travel of the autonomous vehicle 104. The autonomous vehicle 104 may adjust the within-lane positioning in order to avoid coming too close to another vehicle. For example, a safe buffer of two feet may be maintained between the autonomous vehicle 104 and a vehicle travelling the same direction in an adjacent lane. If the autonomous vehicle 104 is positioned off center by some distance that orients the autonomous vehicle 104 too close to the other vehicle, the autonomous vehicle 104 may temporarily or permanently adjust its position. Similarly, if the autonomous vehicle 104 detects that an oncoming vehicle may travel too close (e.g., is traveling very close or over the center line that separates opposing traffic on an undivided roadway), then the autonomous vehicle 104 may temporarily or permanently adjust the travel position within the lane.

Autonomous vehicles are able to platoon with more efficiency and safety due to their ability to sense and react faster than humans. Platooning is understood to be any two or more vehicles that travel in close proximity to one another, nose-to-tail, at travel speeds. Vehicles that are creeping along in stop-and-go traffic are not usually considered to be platooning. Instead, vehicles are considered to be platooning when operating at highway speeds. When platooning, the lead vehicle may establish the lane position and other vehicles that are in the tail of the platoon may follow the lead vehicle's positioning. The position may be communicated from the lead vehicle to the trailing vehicles using vehicle-to-vehicle communication, for example. The lead vehicle may implement one or more modes or techniques that are discussed here.

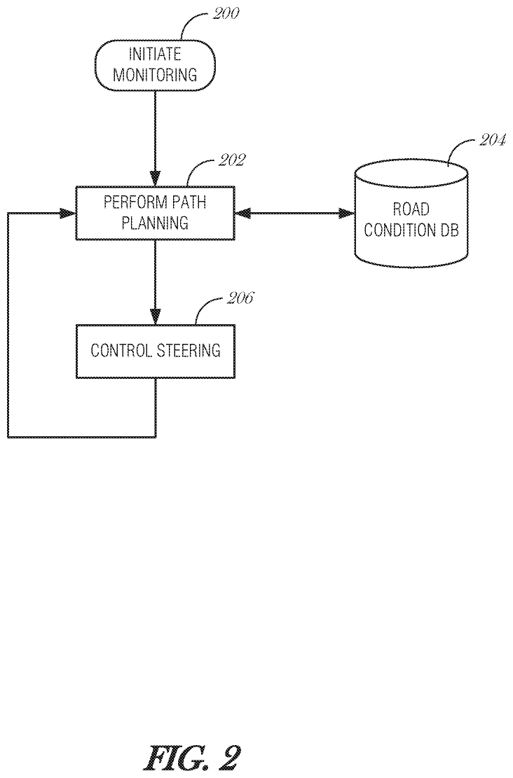

FIG. 2 is a data flow diagram illustrating a process and system to control steering in an autonomous vehicle, according to an embodiment. At operation 200, the data and control flow initiates and the vehicle begins monitoring its environment. Monitoring may be implemented, at least in part, using sensors installed on or in the vehicle. The vehicle may monitor its current geolocation using a location based system (e.g., GPS), planned route, current direction of travel, and the like to identify portions of the travel path that are likely to be traversed. Monitoring may be used in a reactive mode in order for the vehicle to respond in substantially real time to road conditions sensed in the path of travel. Monitoring may also be used in a preemptive mode to determine from previously known information whether the vehicle is likely to encounter a certain type of road condition.

The data collected during operation of the autonomous vehicle may be related to the vehicle's performance, such as acceleration, deceleration, gyrometer, seat sensor data, steering data, and the like. The data may also be related to the vehicle's occupants, operating environment, use, or the like.

At operation 202, the vehicle perform path planning. Path planning may be influenced or determined using the modes and techniques discussed above. For instance, path planning may introduce a random offset from the center of the lane on which the vehicle is travelling. In general, an offset is determined that represents the distance away from the center of the lane that the vehicle will be steered to travel. The offset may a random number within a range. For instance, the offset may be a pseudo-random number in the range [−12, +12], where the range represents the number of inches left (negative) or right (positive) of the center of the lane. This offset may be used to steer the vehicle and maintain a travel vector that is offset from the center of the lane by the offset value. Another example implementation of how a lateral offset from the center of the lane may be determined is illustrated below.

The vehicle's position in the center of the lane may be expressed by Equation 1.

$${dy}_{vehicle} = {dy}_{0} + sin ( ψ + β ) \cdot {dx}_{p} + \frac{\dot{ψ} \cdot {dx}_{p}^{2}}{2 v} + ɛ \qquad Eq . 1$$

In the model expressed in Equation 1, dy_{vehicle} represents the lateral offset of a vehicle with respect to the center of the lane dy₀. Other parameters include are ψ, which represents the vehicle's heading; β, which represents the vehicle slip angles; dxₚ, which represents the vehicle longitudinal velocity; \dot{ψ}, which represents the vehicle's yaw rate; v as vehicle velocity; and dxₚ² as vehicle lateral control. We are adding one more parameter ε to the formula to offset center. ε represents the error value to introduce an offset from center. One or more input parameters may be used to calculate ε.

A simple random seed may be used to determine ε. The random seed may be used to initialize a pseudorandom number generator (RNG). The seed may be determined using various mechanisms, such as by hashing the current time, using a geolocation, or other methods. The resulting pseudorandom number may be normalized, shifted, or otherwise manipulated to represent a value of ε.

Information about vehicles, road obstacles, or other objects nearby, which may be obtained via sensors, networked components, or vehicle-to-vehicle communication, may be used to influence or set ε. Additionally or alternatively, data from subsurface radar imaging may be used to detect worn road segments and select a position for smooth motion and reduced road wear. This road condition information may influence the value of ε.

For instance, path planning may incorporate road condition detection through the use of sensors. In a reactive mode, the vehicle may identify the possible road conditions using sensors on the vehicle. For example, the vehicle may use a VHF radar to identify a structural imperfection in the road in front of the vehicle. Using image analysis, the vehicle control system 102 may determine that the structural imperfection is a road rut or other worn portion of the road. Additionally, after the vehicle traverses a particular road section with a road condition, other sensors may be used to verify or confirm the existence, severity, or identification of the road condition. For example, sensors incorporated into the steering mechanism may be used to detect that the vehicle is tracking in a rut. The data sensed at the time of traversing the road may be stored and shared with other motorists or vehicles. Such data may also be used to improve the classification algorithms used to detect road conditions in the first instance.

In a preemptive mode, the vehicle may access a road condition database 204 to determine the location, type, severity, or other characteristics of road conditions in the vehicle's path. The road condition database 204 may be stored at a user device (e.g., a driver's mobile phone), in the vehicle, or at a network storage location (e.g., cloud service). Alternatively, the road condition database 204 may be stored across several locations. For example, the driver may maintain a road condition database that is relevant to the driver (e.g., routes or locations that are frequented by the driver) and a cloud service may maintain a road condition database of a wider region (e.g., at a national, state, or city level). When the driver is operating within the area that is usually traveled, the local road condition database 204 may be accessed. When the driver moves to a different location, such as on a longer trip during a vacation, the cloud-based road condition database may be accessed by the vehicle control system 102 in order to determine road conditions.

The road condition database 204 may be built contemporaneously while the driver is operating the autonomous vehicle 104. For example, as road condition are observed by the sensors, with the road condition being in the vehicle's driving lane or another lane of traffic, either in the same direction or in another direction of travel, the vehicle may record the road conditions and maneuver the vehicle around them in the future, verify them when on the same roadway at a later time, or share them with other motorists/vehicles for their use in a same or similar road condition avoidance mechanism.

Motion of a vehicle in front of the vehicle may influence or set ε. For instance, if the vehicle negotiates with a lead vehicle to join a platoon, then the vehicle may obtain the ε value from the lead vehicle and use it directly to traverse the road lane using the same lateral offset.

In another instance, the path planning may incorporate the existence of other vehicles on the roadway when determining the path of travel. The autonomous vehicle may detect motions of other vehicles in proximity and adjust its offset in the lane to maintain a safe distance based on the actions of the other vehicles. Information about motions of the other vehicles may be obtained with vehicle-to-vehicle communication.

At operation 206, the autonomous vehicle controls the steering according to the path planning operation 202. Path planning (operation 202) may be performed periodically or regularly. For example, the vehicle may adjust its path every half mile to ensure that it is not helping to form ruts or overusing a portion of the road. The path planning operation 202 may be performed on an interrupt basis, such as when a new vehicle enters the area around the operating vehicle, or when a vehicle leaves a platoon.

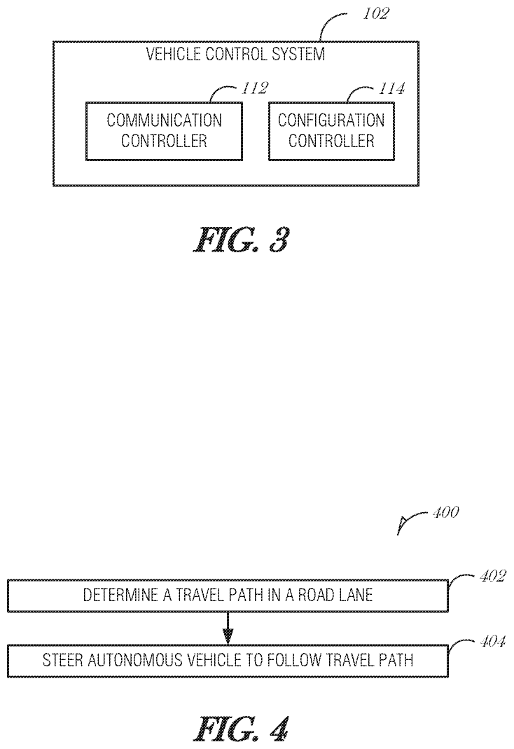

FIG. 3 is a block diagram illustrating a system for managing an autonomous vehicle, according to an embodiment. The system includes a vehicle control system 102 to determine a travel path of the vehicle and steer the vehicle along the travel path.

In an embodiment, the system includes a vehicle control system 102 to determine a travel path in a road lane, the travel path being offset from a center of the road lane by an offset value; and steer the autonomous vehicle to follow the travel path.

In an embodiment, to determine the travel path, the vehicle control system 102 is to calculate the offset value using a random value.

In an embodiment, to determine the travel path, the vehicle control system 102 is to identify a road condition of a road segment in the road lane and calculate the offset value based on the road condition.

In a further embodiment, to identify the road condition, the vehicle control system 102 is to access a database of road conditions, each road condition including a geographical position, and identify the road condition using the geographical position of the potential obstacle and a geographical position of the autonomous vehicle.

In an embodiment, the database of road conditions is populated, at least in part, by a community of drivers. For instance, other vehicles or drivers may upload road conditions that are sensed to the road conditions database. This type of crowdsourced data is useful to ensure updated data.

In an embodiment, the database of road conditions is personal to an operator of the autonomous vehicle. For instance, each driver/operator of the autonomous vehicle may have their own road conditions database that reflects the road conditions of routes that the driver/operator frequently traverses.

In an embodiment, the database of road conditions is stored on a mobile device of an operator of the autonomous vehicle. The database may also be stored in other locations personal to the operator, such as in a key fob.

In an embodiment, to identify the road condition, the vehicle control system is to access sensor data from a sensor array installed on the autonomous vehicle and identify the road condition based on the sensor data. The sensor data may be obtained from a VHF radar, which operates to scan the subsurface of the road. In an embodiment, the sensor data includes image data, and to identify the road condition, the vehicle control system is to use an image classifier to identify the potential obstacle. In an embodiment, the road condition is a road rut.

In an embodiment, to determine the travel path, the vehicle control system 102 is to identify an object near the autonomous vehicle and calculate the offset value based on the object. In a further embodiment, the object is a second vehicle, and to calculate the offset value based on the object, the vehicle control system 102 is to calculate the offset value while maintaining a threshold distance from the second vehicle. The threshold distance may be user-defined or set by the manufacturer. The threshold distance may be based on the speed of the autonomous vehicle, the speed of the nearby vehicle, the type of nearby vehicle, road conditions, weather conditions, time of day, number or type of occupants, or other variables. The threshold distance may be as little as a few inches and as much as a few feet, depending on the type of lanes that are being used (narrow versus wide), accuracy of vehicle pathing, speed of the vehicles, or the like.

In an embodiment, to determine the travel path, the vehicle control system 102 is to negotiate to platoon with a lead vehicle in the road lane and obtain the offset value from the lead vehicle. Negotiation may be as simple as connecting to a lead vehicle and requesting the offset value from the lead vehicle. Negotiation may be over a wireless communication link, such as WiFi, cellular, Bluetooth, or the like. In an embodiment, to negotiate to platoon with the lead vehicle, the vehicle control system uses a vehicle-to-vehicle communication link.

The travel path may be redetermined at regular or periodic intervals. For instance, every five minutes the autonomous vehicle may select a different offset value. As another example, every half a mile, the vehicle may select a different offset value. Other intervals may be used as well. As such, in an embodiment, the vehicle control system 102 is configured to regularly redetermine the travel path.

FIG. 4 is a flowchart illustrating a method 400 of managing an autonomous vehicle, according to an embodiment. At block 402, a travel path in a road lane is determined, where the travel path is offset from a center of the road lane by an offset value. In an embodiment, determining the travel path includes calculating the offset value using a random value.

In an embodiment, determining the travel path includes identifying a road condition of a road segment in the road lane and calculating the offset value based on the road condition. In a further embodiment, identifying the road condition includes accessing a database of road conditions, each road condition including a geographical position, and identifying the road condition using the geographical position of the potential obstacle and a geographical position of the autonomous vehicle. In a further embodiment, the database of road conditions is populated, at least in part, by a community of drivers. In a related embodiment, the database of road conditions is personal to an operator of the autonomous vehicle. In a related embodiment, the database of road conditions is stored on a mobile device of an operator of the autonomous vehicle.

In another embodiment, identifying the road condition includes accessing sensor data from a sensor array installed on the autonomous vehicle and identifying the road condition based on the sensor data. In a further embodiment, the sensor data includes image data, and in such an embodiment, identifying the road condition includes using an image classifier to identify the potential obstacle. In a further embodiment, the sensor data is obtained from a very high frequency radar.

In another embodiment, the road condition is a road rut.

In an embodiment, determining the travel path includes identifying an object near the autonomous vehicle and calculating the offset value based on the object. In a further embodiment, the object is a second vehicle, and in such an embodiment, calculating the offset value based on the object includes calculating the offset value while maintaining a threshold distance from the second vehicle.

In an embodiment, determining the travel path includes negotiating to platoon with a lead vehicle in the road lane and obtaining the offset value from the lead vehicle. In a further embodiment, negotiating to platoon with the lead vehicle includes using a vehicle-to-vehicle communication link.

At block 402, the autonomous vehicle is steered to follow the travel path. In an embodiment, the method 400 includes regularly redetermining the travel path. The vehicle may then be steered to the new travel path.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a fibrin readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (CPU), a digital signal processor (DSP), a field programmable gate array (FPGA), or a fixed function processor.

Examples, as described herein, may include, or may operate on, logic or a number of components, modules, controllers, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

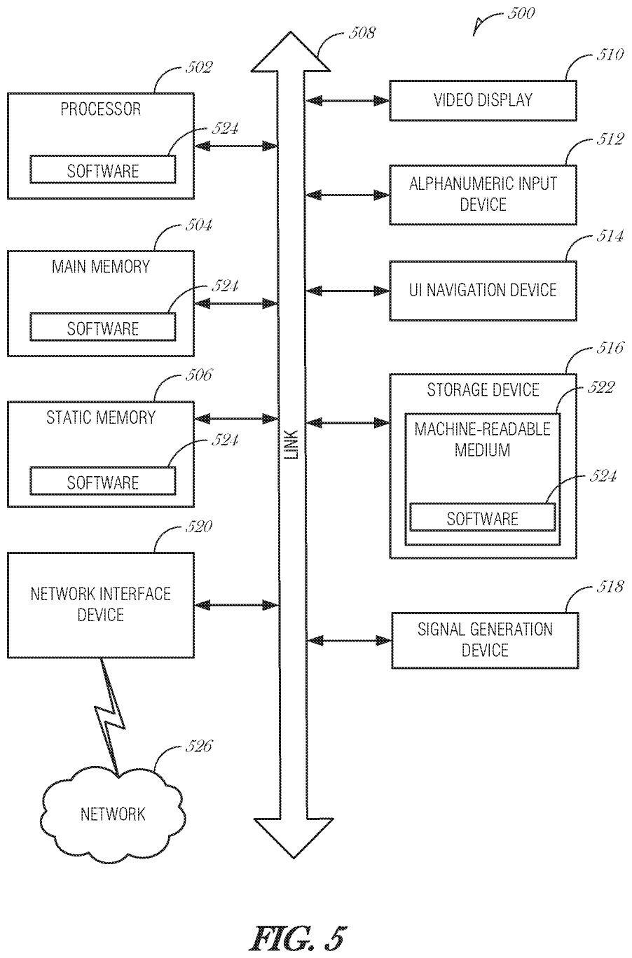

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for managing an autonomous vehicle, the system comprising: a vehicle control system to: determine a travel path in a road lane, the travel path being offset from a center of the road lane by an offset value; and steer the autonomous vehicle to follow the travel path.

In Example 2, the subject matter of Example 1 includes, wherein to determine the travel path, the vehicle control system is to calculate the offset value using a random value.

In Example 3, the subject matter of Examples 1-2 includes, wherein to determine the travel path, the vehicle control system is to: identify a road condition of a road segment in the road lane; and calculate the offset value based on the road condition.

In Example 4, the subject matter of Example 3 includes, wherein to identify the road condition, the vehicle control system is to: access a database of road conditions, each road condition including a geographical position; and identify the road condition using the geographical position of the potential obstacle and a geographical position of the autonomous vehicle.

In Example 5, the subject matter of Example 4 includes, wherein the database of road conditions is populated, at least in part, by a community of drivers.

In Example 6, the subject matter of Examples 4-5 includes, wherein the database of road conditions is personal to an operator of the autonomous vehicle.

In Example 7, the subject matter of Examples 4-6 includes, wherein the database of road conditions is stored on a mobile device of an operator of the autonomous vehicle.

In Example 8, the subject matter of Examples 3-7 includes, wherein to identify the road condition, the vehicle control system is to: access sensor data from a sensor array installed on the autonomous vehicle; and identify the road condition based on the sensor data.

In Example 9, the subject matter of Example 8 includes, wherein the sensor data includes image data, and wherein to identify the road condition, the vehicle control system is to use an image classifier to identify the potential obstacle.

In Example 10, the subject matter of Example 9 includes, wherein the sensor data is obtained from a very high frequency radar.

In Example 11, the subject matter of Examples 3-10 includes, wherein the road condition is a road rut.

In Example 12, the subject matter of Examples 1-11 includes, wherein to determine the travel path, the vehicle control system is to: identify an object near the autonomous vehicle; and calculate the offset value based on the object.

In Example 13, the subject matter of Example 12 includes, wherein the object is a second vehicle, and wherein to calculate the offset value based on the object, the vehicle control system is to: calculate the offset value while maintaining a threshold distance from the second vehicle.

In Example 14, the subject matter of Examples 1-13 includes, wherein to determine the travel path, the vehicle control system is to: negotiate to platoon with a lead vehicle in the road lane; and obtain the offset value from the lead vehicle.

In Example 15, the subject matter of Example 14 includes, wherein to negotiate to platoon with the lead vehicle, the vehicle control system uses a vehicle-to-vehicle communication link.

In Example 16, the subject matter of Examples 1-15 includes, wherein the vehicle control system is configured to regularly redetermine the travel path.

Example 17 is a method of managing an autonomous vehicle, the method comprising: determining a travel path in a road lane, the travel path being offset from a center of the road lane by an offset value; and steering the autonomous vehicle to follow the travel path.

In Example 18, the subject matter of Example 17 includes, wherein determining the travel path comprises calculating the offset value using a random value.

In Example 19, the subject matter of Examples 17-18 includes, wherein determining the travel path comprises: identifying a road condition of a road segment in the road lane; and calculating the offset value based on the road condition.

In Example 20, the subject matter of Example 19 includes, wherein identifying the road condition comprises: accessing a database of road conditions, each road condition including a geographical position; and identifying the road condition using the geographical position of the potential obstacle and a geographical position of the autonomous vehicle.

In Example 21, the subject matter of Example 20 includes, wherein the database of road conditions is populated, at least in part, by a community of drivers.

In Example 22, the subject matter of Examples 20-21 includes, wherein the database of road conditions is personal to an operator of the autonomous vehicle.

In Example 23, the subject matter of Examples 20-22 includes, wherein the database of road conditions is stored on a mobile device of an operator of the autonomous vehicle.

In Example 24, the subject matter of Examples 19-23 includes, wherein identifying the road condition comprises: accessing sensor data from a sensor array installed on the autonomous vehicle; and identifying the road condition based on the sensor data.

In Example 25, the subject matter of Example 24 includes, wherein the sensor data includes image data, and wherein identifying the road condition comprises using an image classifier to identify the potential obstacle.

In Example 26, the subject matter of Example 25 includes, wherein the sensor data is obtained from a very high frequency radar.

In Example 27, the subject matter of Examples 19-26 includes, wherein the road condition is a road rut.

In Example 28, the subject matter of Examples 17-27 includes, wherein determining the travel path comprises: identifying an object near the autonomous vehicle; and calculating the offset value based on the object.

In Example 29, the subject matter of Example 28 includes, wherein the object is a second vehicle, and wherein calculating the offset value based on the object comprises: calculating the offset value while maintaining a threshold distance from the second vehicle.

In Example 30, the subject matter of Examples 17-29 includes, wherein determining the travel path comprises: negotiating to platoon with a lead vehicle in the road lane; and obtaining the offset value from the lead vehicle.

In Example 31, the subject matter of Example 30 includes, wherein negotiating to platoon with the lead vehicle comprises using a vehicle-to-vehicle communication link.

In Example 32, the subject matter of Examples 17-31 includes, regularly redetermining the travel path.

Example 33 is at least one machine-readable medium including instructions, which when executed by a machine, cause the machine to perform operations of any of the methods of Examples 17-32.

Example 34 is an apparatus comprising means for performing any of the methods of Examples 17-32.

Example 35 is an apparatus for managing an autonomous vehicle, the apparatus comprising: means for determining a travel path in a road lane, the travel path being offset from a center of the road lane by an offset value; and means for steering the autonomous vehicle to follow the travel path.

In Example 36, the subject matter of Example 35 includes, wherein the means for determining the travel path comprise means for calculating the offset value using a random value.

In Example 37, the subject matter of Examples 35-36 includes, wherein the means for determining the travel path comprise: means for identifying a road condition of a road segment in the road lane; and means for calculating the offset value based on the road condition.

In Example 38, the subject matter of Example 37 includes, wherein the means for identifying the road condition comprise: means for accessing a database of road conditions, each road condition including a geographical position; and means for identifying the road condition using the geographical position of the potential obstacle and a geographical position of the autonomous vehicle.

In Example 39, the subject matter of Example 38 includes, wherein the database of road conditions is populated, at least in part, by a community of drivers.

In Example 40, the subject matter of Examples 38-39 includes, wherein the database of road conditions is personal to an operator of the autonomous vehicle.

In Example 41, the subject matter of Examples 38-40 includes, wherein the database of road conditions is stored on a mobile device of an operator of the autonomous vehicle.

In Example 42, the subject matter of Examples 37-41 includes, wherein the means for identifying the road condition comprise: means for accessing sensor data from a sensor array installed on the autonomous vehicle; and means for identifying the road condition based on the sensor data.

In Example 43, the subject matter of Example 42 includes, wherein the sensor data includes image data, and wherein the means for identifying the road condition comprise means for using an image classifier to identify the potential obstacle.

In Example 44, the subject matter of Example 43 includes, wherein the sensor data is obtained from a very high frequency radar.

In Example 45, the subject matter of Examples 37-44 includes, wherein the road condition is a road rut.

In Example 46, the subject matter of Examples 35-45 includes, wherein the means for determining the travel path comprise: means for identifying an object near the autonomous vehicle; and means for calculating the offset value based on the object.

In Example 47, the subject matter of Example 46 includes, wherein the object is a second vehicle, and wherein calculating the offset value based on the object comprises: calculating the offset value while maintaining a threshold distance from the second vehicle.

In Example 48, the subject matter of Examples 35-47 includes, wherein the means for determining the travel path comprise: means for negotiating to platoon with a lead vehicle in the road lane; and means for obtaining the offset value from the lead vehicle.

In Example 49, the subject matter of Example 48 includes, wherein the means for negotiating to platoon with the lead vehicle comprise means for using a vehicle-to-vehicle communication link.

In Example 50, the subject matter of Examples 35-49 includes, wherein the apparatus is configured to regularly redetermine the travel path.

Example 51 is at least one machine-readable medium including instructions for managing an autonomous vehicle, which when executed by a machine, cause the machine to perform the operations comprising: determining a travel path in a road lane, the travel path being offset from a center of the road lane by an offset value; and steering the autonomous vehicle to follow the travel path.

In Example 52, the subject matter of Example 51 includes, wherein determining the travel path comprises calculating the offset value using a random value.

In Example 53, the subject matter of Examples 51-52 includes, wherein determining the travel path comprises: identifying a road condition of a road segment in the road lane; and calculating the offset value based on the road condition.

In Example 54, the subject matter of Example 53 includes, wherein identifying the road condition comprises: accessing a database of road conditions, each road condition including a geographical position; and identifying the road condition using the geographical position of the potential obstacle and a geographical position of the autonomous vehicle.

In Example 55, the subject matter of Example 54 includes, wherein the database of road conditions is populated, at least in part, by a community of drivers.

In Example 56, the subject matter of Examples 54-55 includes, wherein the database of road conditions is personal to an operator of the autonomous vehicle.

In Example 57, the subject matter of Examples 54-56 includes, wherein the database of road conditions is stored on a mobile device of an operator of the autonomous vehicle.

In Example 58, the subject matter of Examples 53-57 includes, wherein identifying the road condition comprises: accessing sensor data frog a sensor array installed on the autonomous vehicle; and identifying the road condition based on the sensor data.

In Example 59, the subject matter of Example 58 includes, wherein the sensor data includes image data, and wherein identifying the road condition comprises using an image classifier to identify the potential obstacle.

In Example 60, the subject matter of Example 59 includes, wherein the sensor data is obtained from a very high frequency radar.

In Example 61, the subject matter of Examples 53-60 includes, wherein the road condition is a road rut.

In Example 62, the subject matter of Examples 51-61 includes, wherein determining the travel path comprises: identifying an object near the autonomous vehicle; and calculating the offset value based on the object.

In Example 63, the subject matter of Example 62 includes, wherein the object is a second vehicle, and wherein calculating the offset value based on the object comprises: calculating the offset value while maintaining a threshold distance from the second vehicle.

In Example 64, the subject matter of Examples 51-63 includes, wherein determining the travel path comprises: negotiating to platoon with a lead vehicle in the road lane; and obtaining the offset value from the lead vehicle.

In Example 65, the subject matter of Example 64 includes, wherein negotiating to platoon with the lead vehicle comprises using a vehicle-to-vehicle communication link.

In Example 66, the subject matter of Examples 51-65 includes, regularly redetermining the travel path.

Example 67 is at least one machine-readable medium including instructions that, when executed by processing circuitry, cause the processing circuitry to perform operations to implement of any of Examples 1-66.

Example 68 is an apparatus comprising means to implement of any of Examples 1-66.

Example 69 is a system to implement of any of Examples 1-66.

Example 70 is a method to implement of any of Examples 1-66.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. A system for managing an autonomous vehicle, the system comprising:
a vehicle control system to:
determine a travel path in a road lane, the travel path being offset from a center of the road lane by an offset value; and
steer the autonomous vehicle to follow the travel path.

27. The system of claim 26, wherein to determine the travel path, the vehicle control system is to calculate the offset value using a random value.

28. The system of claim 1, wherein to determine the travel path, the vehicle control system is to:
identify a road condition of a road segment in the road lane; and
calculate the offset value based on the road condition.

29. The system of claim 28, wherein to identify the road condition, the vehicle control system is to:
access a database of road conditions, each road condition including a geographical position; and
identify the road condition using the geographical position of the potential obstacle and a geographical position of the autonomous vehicle.

30. The system of claim 29, wherein the database of road conditions is populated, at least in part, by a community of drivers.

31. The system of claim 28, wherein to identify the road condition, the vehicle control system is to:
access sensor data from a sensor array installed on the autonomous vehicle; and
identify the road condition based on the sensor data.

32. The system of claim 31, wherein the sensor data includes image data, and wherein to identify the road condition, the vehicle control system is to use an image classifier to identify the potential obstacle.

33. The system of claim 32, wherein the sensor data is obtained from a very high frequency radar.

34. The system of claim 26, wherein to determine the travel path, the vehicle control system is to:
negotiate to platoon with a lead vehicle in the road lane; and
obtain the offset value from the lead vehicle.

35. The system of claim 34, wherein to negotiate to platoon with the lead vehicle, the vehicle control system uses a vehicle-to-vehicle communication link.

36. A method of managing an autonomous vehicle, the method comprising:
determining a travel path in a road lane, the travel path being offset from a center of the road lane by an offset value; and
steering the autonomous vehicle to follow the travel path.

37. The method of claim 36, wherein determining the travel path comprises calculating the offset value using a random value.

38. The method of claim 36, wherein determining the travel path comprises:
identifying a road condition of a road segment in the road lane; and
calculating the offset value based on the road condition.

39. The method of claim 38, wherein identifying the road condition comprises:
accessing a database of road conditions, each road condition including a geographical position; and
identifying the road condition using the geographical position of the potential obstacle and a geographical position of the autonomous vehicle.

40. The method of claim 39, wherein the database of road conditions is populated, least in part, by a community of drivers.

41. The method of claim 39, wherein the database of road conditions is personal to an operator of the autonomous vehicle.

42. The method of claim 39, wherein the database of road conditions is stored on a mobile device of an operator of the autonomous vehicle.

43. The method of claim 38, wherein identifying the road condition comprises:
accessing sensor data from a sensor array installed on the autonomous vehicle; and
identifying the road condition based on the sensor data.

44. The method of claim 43, wherein the sensor data includes image data, and wherein identifying the road condition comprises using an image classifier to identify the potential obstacle.

45. The method of claim 44, wherein the sensor data is obtained from a very high frequency radar.

46. The method of claim 38, wherein the road condition is a road rut.

47. The method of claim 36, wherein determining the travel path comprises:
identifying an object near the autonomous vehicle; and
calculating the offset value based on the object.

48. The method of claim 47, wherein the object is a second vehicle, and wherein calculating the offset value based on the object comprises:
calculating the offset value while maintaining a threshold distance from the second vehicle.

49. At least one non-transitory machine-readable medium including instructions for managing an autonomous vehicle, which when executed by a machine, cause the machine to perform the operations comprising:
determining a travel path in a road lane, the travel path being offset from a center of the road lane by an offset value; and
steering the autonomous vehicle to follow the travel path.

50. The at least one non-transitory machine-readable medium of claim 49, wherein determining the travel path comprises calculating the offset value using a random value.
